(19) United States
(12) Patent Application Publication
(10) Pub. No.: US 2008/0121687 A1
(43) Pub. Date: May 29, 2008

(54) METHOD AND SYSTEM FOR DETECTING AN END OF TRANSACTION FOR CONTACTLESS TRANSACTIONS ON A MOBILE DEVICE

(75) Inventor: THOMAS BUHOT, TOULOUSE MIDI PYRENEES (FR)

Correspondence Address: AKERMAN SENTERFITT, P.O. BOX 3188, WEST PALM BEACH, FL, 33402-3188, US

(73) Assignee: MOTOROLA, INC., SCHAUMBURG, IL (US)

(21) Appl. No.: 11/745,354

(22) Filed: May 7, 2007

Related U.S. Application Data
(60) Provisional application No. 60/867,489, filed on Nov. 28, 2006.

(51) Int. Cl. G06F 7/02

(52) U.S. Cl. 235/375

(57) ABSTRACT

A system (100) and method (200) for NFC/UICC and NFC/RFID contactless transaction validation suitable for use in a mobile device (110) is provided. The system can include a Near Field Communication (NFC) modem (140), a NFC Universal Integrated Circuit Card (NFC-UICC) (130), and an application processor (120) for informing the mobile device of an end of transaction in the contactless data transaction. The NFC-UICC can detect the end of transaction from the NFC modem via state transitions and informs the application processor via a status word that an end of transaction for the contactless data transaction has been confirmed. The system can include an NFC application (132) for monitoring data communication and an NFC-UICC toolkit application (136) for providing proactive command support to the mobile device and providing notification through the status word.

### CROSS REFERENCE TO RELATED APPLICATIONS

This application claims the benefit of U.S. Provisional Patent Application No. 60/867,489, filed Nov. 28, 2006, the entire contents of which are incorporated by reference herein.

### FIELD OF THE INVENTION

The present invention relates to mobile devices, and more particularly, to contactless transactions using a mobile device.

### Introduction

The use of portable electronic devices and mobile communication devices has increased dramatically in recent years. Moreover, the demand for mobile devices that allow users to conduct contactless transactions is increasing. Near Field Communication technology (NFC) enables mobile devices to act as an electronic data transaction device. As one example, NFC can be used to perform contactless financial transactions such as those requiring a credit card. The user may select credit card information stored in the mobile device and perform contactless payments in a quick way by “tapping” or “waving” the mobile device in front of a contactless reader terminal. A reader terminal can read the credit card information and process a financial transaction. NFC can be coupled with an UICC (Universal Integrated Circuit Card) chip card used in mobile terminals in GSM (Global System for Mobile), UMTS (Universal Mobile Telecommunications System) or other networks to provide contactless payment transactions. The UICC can contain telecom applications such as SIM, USIM or others and can provide secure credit card information to the reader terminal using the NFC technology. In the foregoing, a UICC that provides such features through NFC is called NFC-UICC.

The mobile device can provide an indication, such as a chime or animated graphic, for informing the user when a contactless transaction has ended. A contactless transaction has ended when the credit card information, or other account information, has been successfully read by the reader terminal. For example, the transaction ends successfully if the entire credit card information stored into the NFC-UICC has been successfully read. During contactless payment transactions, it is not always guaranteed that a reader terminal will successfully read the credit card information. The contactless transaction may fail if only part of the credit card information has been read. It should also be noted, that once the reader has read the credit card information, an entity associated with the reader, such as a banking system, may accept or reject the contactless transaction. For instance, a banking system may reject the transaction if the balance of the account is insufficient for the payment even though the reading of the credit card information was technically successful. Whereas a banking transaction may fail when there is not enough money on the account, the mobile device transaction for providing the credit card information may succeed if the credit card information is read successfully.

In order to provide an indication for a successful read status, the reader should provide the mobile device with a confirmation that the credit card information was completely read. However, due to security restriction requirements, the mobile device is not authorized to evaluate secure transactions between the UICC and the reader terminal. That is, the mobile device is insulated from secure transactions occurring between the UICC and the reader terminal, even though the UICC is on the mobile device. Accordingly, the user may not have any means of knowing whether the credit card, or other secure data, was successfully read. In current NFC-UICC technology, the mobile device can only monitor radio frequency (RF) events between the mobile device and the reader. To determine if a credit card has been successfully read, in the NFC-UICC or in any other embedded secured module (or secured integrated circuit such as memory cards), the mobile device must analyze RF signals and make suppositions on what happened during the contactless transaction. This is an uncertain solution incapable of detecting an end of contactless transaction. In such regard, monitoring RF signals alone does not allow the mobile device to accurately inform the user for end of transaction events.

For example, referring to FIG. 1, a system of the prior art for NFC-UICC is shown. The system 100 can include a mobile device 110 and a reader terminal 170 for processing contactless transactions. The mobile device 110 can include an antenna for communicating passive or active RF signals within an RF field 150 of the reader terminal 170. In one arrangement, the reader terminal 170 may be a payment terminal for conducting financial transactions such as reading credit information from the mobile device 110. The mobile device 110 can include an application processor 120 for providing a user interface for the contactless transactions, an NFC-UICC 130 that informs the application processor 120 of UICC transactions and that provides secure credit card information, and a NFC modem 140 for communicating the credit card information to the reader terminal 170.

The NFC-UICC 130 can include a first OS (Operating System) for telecommunications and a second OS dedicated for NFC contactless transactions (if the second OS is absent its role can be replaced by the first one). The second OS is responsible for the NFC application execution into the UICC and may support different kind of NFC applications at the same time, such as contactless payment, ticketing applications, fidelity applications, and the like. Both the first OS and the second OS can securely communicate and exchange data. As per existing banking standards, virtual payment cards can be used to conduct the contactless payment transaction with the reader terminal 170. The virtual payment cards can be applications or applications based on the JavaCard™ technology or any other standardized or proprietary technologies loaded and installed into the second OS of the NFC-UICC 130. These contactless applications hold the same data as the one in a contact or contactless credit card, such as cardholder information data, cryptographic keys, cardholder authentication procedures (personal identification numbers, biometrics, etc). For instance these applications may be provided either by a bank, a credit card agency, a telecommunication operator, or a third party and may consist in one or more applications installed and running in the NFC-UICC 130.

In a contactless payment scenario, data exchange between the reader terminal (payment terminal) 170 and the NFC-UICC 130 is performed over-the-air using an NFC protocol. The NFC-UICC 130 acts as a real contactless card and handles all external requests from the reader terminal 170 itself through the NFC modem 140 over communication link 3 (132). The link 3 (132) is defined by the card manufacturer and may be a proprietary one such as a SWP (Single Wire Protocol) implementation or a standardized one such as a MMC (Multi Media Card) implementation. Any data exchange between the application processor 120 and the NFC-UICC 130 is performed through the physical line link 1 (122). The communication link 122 may be one as defined in ISO17816 standards. Any data exchange between the application processor 120 and the NFC modem 140 is done through the communication link 2 (160). The communication link 160 is typically involved during the NFC payment application initialization and termination phase to manage the NFC modem 140 resource. The communication link 160 is used to monitor RF events at the NFC modem side, and may be based on proprietary or standardized protocols such as WI (Wired Interface) or UART (Universal Asynchronous Receiver Transmitter).

In particular, as shown in FIG. 1, the application processor 120 can only communicate with the NFC modem 140 over Link 2 160. Link 2 160 only provides for monitoring of RF events on the side of the mobile device 110. That is, the Link 2 does not provide any information as to whether the reader 170 successfully read or processed contactless transactions with the NFC-UICC 130. In such regard, the application processor 120 cannot confirm whether the reader 170 completed the contactless transaction, nor monitor end of transaction events directly between the NFC-UICC 130 and the NFC modem 140. Due to security restrictions, the application processor 120 cannot access transaction information in the NFC-UICC 130. Only RF events in the RF field 150 can be monitored by the application processor 120. Monitoring RF events in the RF field 150 does not provide a true indication for an end of transaction event due to peculiarities of movement between the mobile device and the reader terminal. As an example, variations in the RF field 150 strength as a result of intensity changes in the neighborhood of the reader terminal 170 can produce false end of transactions. For example, the user may move the mobile device 110 to rapidly in the RF field 150, or insufficiently close to the reader terminal 170. Moreover, the RF field 150 can be payment terminal-dependent such that the end of transaction notification on the mobile device 110 may vary from one terminal to another. Some terminals may not switch off their RF field 150 at the end of the transaction. Furthermore, in the current implementation of NFC-UICC as shown in FIG. 1, monitoring the RF field 150 may require switching the NFC communication link 3 (132) configuration between the NFC modem 140 and the NFC-UICC secured module 130 on the mobile device 110 which may reset any pending payment transaction. A need therefore exists for providing an indication for an end of transaction that does not rely on monitoring RF events in an RF field.

### SUMMARY

Broadly stated, embodiments of the invention are directed to a system and method for NFC-UICC contactless transaction validation suitable for use in a mobile device. The NFC/UICC system can include a Near Field Communication (NFC) modem for receiving radio frequency (RF) signals associated with a contactless data transaction, an NFC Universal Integrated Circuit Card (NFC-UICC) communicatively coupled to the NCF modem for providing security to the contactless data transaction, and an application processor communicatively coupled to the NFC-UICC for informing the mobile device of an end of transaction in the contactless data transaction. In one arrangement, the NFC-UICC can detect an end of transaction from the NFC modem via state transitions and inform the application processor via a status word that an end of transaction for the contactless data transaction has been confirmed. In one arrangement, the status word can be received in response to a Terminal Response proactive command. In one aspect, the contactless data transaction can be a payment transaction and the end of transaction indicates that credit card information on the mobile device has been successfully read by an entity performing the contactless payment transaction with the NFC modem. As an example, the end of transaction can correspond to a contactless event related to software running on the NFC-UICC such as ticketing, cash card, access control, or WI-FI and Bluetooth set-up. The application processor can include a payment application that presents a graphical user interface to inform a user of the end of transaction for the contactless data transaction upon the application processor receiving the status word from the NFC-UICC for the end of transaction. The status word can further include account information such as credit balance, credit brand information, merchant information, or credit card logos that are displayable on the mobile device. The

The NFC-UICC can further include an NFC application for monitoring data communication and determining the end of transaction for the contactless data transaction with the NFC modem, and NFC-UICC toolkit application for providing proactive command support to the mobile device and providing notification of the end of transaction to the NFC payment application through the status word. The NFC payment application can implement a Java™ messaging Application Programming Interface (API) for conveying the status word and event occurrences between the NFC payment application and the application processor. The NFC-UICC can also include a shared memory such as a mailbox for allowing the NFC application and the NFC-UICC toolkit application to securely share information.

The method for secure contactless payment transaction can include monitoring payment application state transitions during a payment transaction in real-time, detecting a read event on a Near Field Communication Universal Integrated Circuit Card (NFC-UICC) card of a mobile device during the payment transaction, and notifying the mobile device of the read event via a status word for an end of transaction associated with a completion of the read event. The step of monitoring the payment application state transitions can include selecting an UICC toolkit application in a NFC-UICC to initiate a contactless payment transaction, informing an NFC payment application in the NFC-UICC that a payment transaction will occur using the UICC toolkit, informing the UICC toolkit application of state transitions by the NFC payment application during the contactless payment transaction, and informing the mobile device of the end of transaction for the contactless payment through proactive commands by the UICC toolkit application. A read event can be detected on the NFC-UICC by monitoring a time to execute a credit card read sequence of a pending contactless payment. In one arrangement, more time can be provided to complete the pending contactless payment if the time is insufficient to complete execution of the credit card read sequence.

Embodiments of the invention are also directed to an NFC/RFID system for enhanced read complete indication. The NFC/RFID system can include a mobile device having a phone card for providing contactless data transactions and presenting transaction events through a user interface, and a reader external from the mobile device that reads the phone card information from the mobile device when the mobile device is in proximity to a radio frequency (RF) field of the reader. Upon completion of a contactless data transaction, the reader can send an acknowledgment to the mobile device confirming that information from the phone card has been successfully read, and the user interface informs the user of the transaction status. The acknowledgment can be a Transaction Acknowledgement (TACK) confirming receipt of transaction data. The TACK can provide additional information related to the contactless data transaction, such as a logo of a card issuer, a credit card brand, an application identifier, ticketing, cash card, access control, or configuration information (WI-FI, Bluetooth or etc) that is displayable on the user interface. The mobile device can include a secure controller conducting contactless payment applications with the reader and an NFC/RFID controller, and a messaging Applications Programming Interface (API) operatively coupled to the secure controller for informing the mobile device of contactless transaction events. The messaging API can operate on hardware interrupts for signaling occurrence of contactless transaction events.

### BRIEF DESCRIPTION OF THE DRAWINGS

The features of the system, which are believed to be novel, are set forth with particularity in the appended claims. The embodiments herein can be understood by reference to the following description, taken in conjunction with the accompanying drawings, in the several figures of which like reference numerals identify like elements, and in which:

FIG. 1 is a Near Field Communication Universal Integrated Circuit Card (NFC-UICC) system of the prior art for contactless transactions in accordance with the embodiments of the invention;

FIG. 2 is a NFC-UICC system for identifying an end of transaction in accordance with the embodiments of the invention;

FIG. 3 is a status word for communicating the end of transaction in accordance with the embodiments of the invention;

FIG. 4 is a proposed modification to the ETSI TS 102 221 to include the status word of FIG. 3 in accordance with the embodiments of the invention;

FIG. 5 is a flowchart for indicating the end of transaction using the status word in accordance with the embodiments of the invention;

### DETAILED DESCRIPTION

While the specification concludes with claims defining the features of the embodiments of the invention that are regarded as novel, it is believed that the method, system, and other embodiments will be better understood from a consideration of the following description in conjunction with the drawing figures, in which like reference numerals are carried forward.

As required, detailed embodiments of the present method and system are disclosed herein. However, it is to be understood that the disclosed embodiments are merely exemplary, which can be embodied in various forms. Therefore, specific structural and functional details disclosed herein are not to be interpreted as limiting, but merely as a basis for the claims and as a representative basis for teaching one skilled in the art to variously employ the embodiments of the present invention in virtually any appropriately detailed structure. Further, the terms and phrases used herein are not intended to be limiting but rather to provide an understandable description of the embodiment herein.

The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

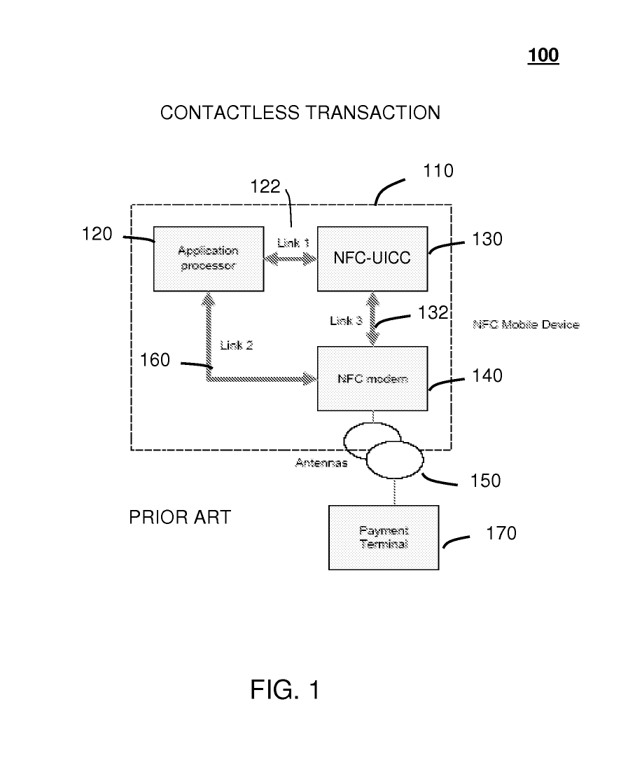

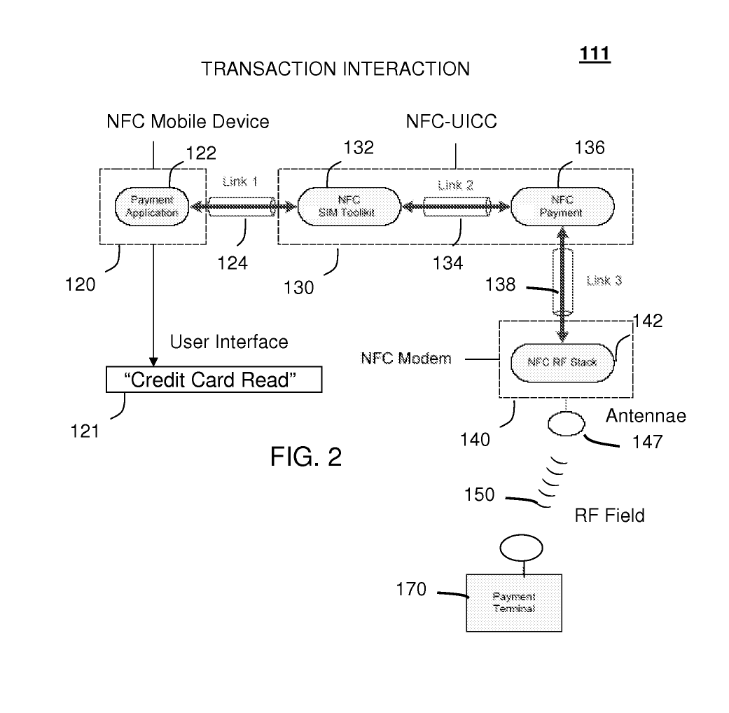

Referring to FIG. 2, a block diagram for a NFC-UICC contactless transaction system 111 is shown. The NFC-UICC system 111 can be included within a mobile device, a portable music player, a personal digital assistant, a mobile data storage unit, a personal security device or any other suitable electronic or communication device. The components of the system 111 can be implemented in software by a processor such as a microprocessor or a digital signal processor (DSP) as is known in the art, or in hardware such as an ASIC (Application Specific Integrated Circuit) or FPGA (Field Programmable Gate Array) as is known in the art. The system 111 can include a Near Field Communication (NFC) modem 140 for receiving radio frequency (RF) signals via an antennae 147 associated with a contactless data transaction, an NFC Universal Integrated Circuit Card (NFC-UICC) 130 communicatively coupled to the NCF modem 140 for providing security to the contactless data transaction, and an application processor 120 communicatively coupled to the NFC-UICC 130 for informing a mobile device implementing the system 111 of an end of transaction in the contactless data transaction. In particular, the NFC-UICC 130 detects an end of transaction from the NFC modem 140 and informs the application processor 120 via a status word that an end of transaction for the contactless data transaction has been confirmed. Briefly, the system 111 of FIG. 2 removes the Link 2 160 (see FIG. 1) between the application processor 120 and the NFC modem 140 for monitoring RF signals to detect end of transaction events. The use of the status word to signify an end of transaction event obviates Link 2 (160).

The NFC-UICC 130 can further include an NFC application 136 for monitoring data communication and determining the end of transaction for the contactless data transaction with the NFC modem, and an NFC-UICC toolkit application 132 for providing proactive command support to the mobile device and providing notification of the end of transaction to the NFC payment application through the status word. The NFC application 136 can implement a Java™ messaging Application Programming Interface (API) for conveying the status word and event occurrences between the NFC application 136 and the application processor 120.

As an example, the contactless transaction system 111 can be used for contactless financial transactions. The contactless transaction system 111 involves the three software applications: the NFC application 136, the NFC-UICC toolkit application 132, and the payment application 122. The mobile device embeds the Contactless Payment Application 122 to allow the user access to payment functionality. The Payment Application 122 drives the user interface 121 of the mobile device for payment. The application processor 120 can present the payment application 122 for communicating a result of financial transactions to the user. For example, the user interface 121 can inform a user when a transaction has ended which may occur when a credit card stored in the NFC-UICC 130 is successfully read by a reader terminal. The NFC-UICC 130 embeds the NFC-UICC toolkit application 132 that is responsible for the proactive command exchanges with the mobile device. The NFC-UICC toolkit application 132 can provide proactive commands as defined by the UICC toolkit standard of ETSI TS 102 223. In such regard, both the NFC mobile and the NFC-UICC 130 can also be configured to support the UICC toolkit standard. The NFC-UICC 130 also embeds the NFC Payment Application 136 for purposes of conducting financial transactions for payment through the NFC modem 142 to a reader terminal (not shown).The payment application 122 and the NFC Payment Application 136 can communicate and exchange data using an internal mechanism into the NFC-UICC, such as the one defined by the JavaCard™ technology. The JavaCard™ technology allows different applications to share memory and data objects in a secure way. Regular Smart Cards, which are emulated by a mobile device, do not include hardware or software resources to provide Application Programming Interfaces (API) to a mobile device during secure applications due to independent plastic cards utilizations and strict secure requirements to closed secure applications such as payments, identity, access control, and the like.

In practice, a user can wave a mobile device implementing the contactless transaction system 111 in front of a reader for performing payment transactions. When the user selects the Payment Application on his phone to perform a contactless payment, the following events occur:
1. The Payment Application 122 in the mobile device is activated.
2. The Payment Application 122 selects the NFC UICC Toolkit Application 132 from the NFC-UICC 130 to initiate a contactless payment. At this moment the application communication Link 1 (124) is established between the Payment Application 122 and the NFC UICC Toolkit Application 132.
3. Inside the NFC-UICC 130, the NFC UICC Toolkit Application 132 informs the NFC Payment Application 136 to start a contactless payment session. The application communication Link 2 (134) is established between the NFC-UICC Toolkit Application 132 and the NFC Payment Application 136.
4. The user waves the mobile device in front of the payment reader terminal (not shown). The application communication Link 3 (138) between the NFC Modem 140 and the NFC Payment Application 136 is activated once the mobile device enters the RF field of the payment reader terminal. Then, the payment terminal retrieves the credit card information OTA (Over The Air) through Link 3 (138).
5. During the payment session, the NFC Payment Application 136 informs the NFC UICC Toolkit Application 132 from its internal state transitions through the communication Link 2 (134).
6. Once the full credit card information has been sent to the payment terminal, the NFC Payment Application 136 notifies the NFC UICC Toolkit Application 132 that informs the Payment Application 122 of the end of the payment transaction. The NFC UICC Toolkit application communicates with the Payment Application into the mobile through proactive command exchanges. The proactive command mechanism is defined in the ETSI TS 102 223 and ETSI TS 102 221 standards. This mechanism has been defined for the UICC to initiate communication with a reader terminal (the mobile device there 120). When using the standard T=0 or T=1 protocols the reader terminal 120 is always the master to communicate with the UICC. In particular, the Payment Application 122 receives a status word denoting the end of transaction. In the financial payment example, an “end of transaction status” is used indicates that the credit card information was successfully read by the payment reader terminal.

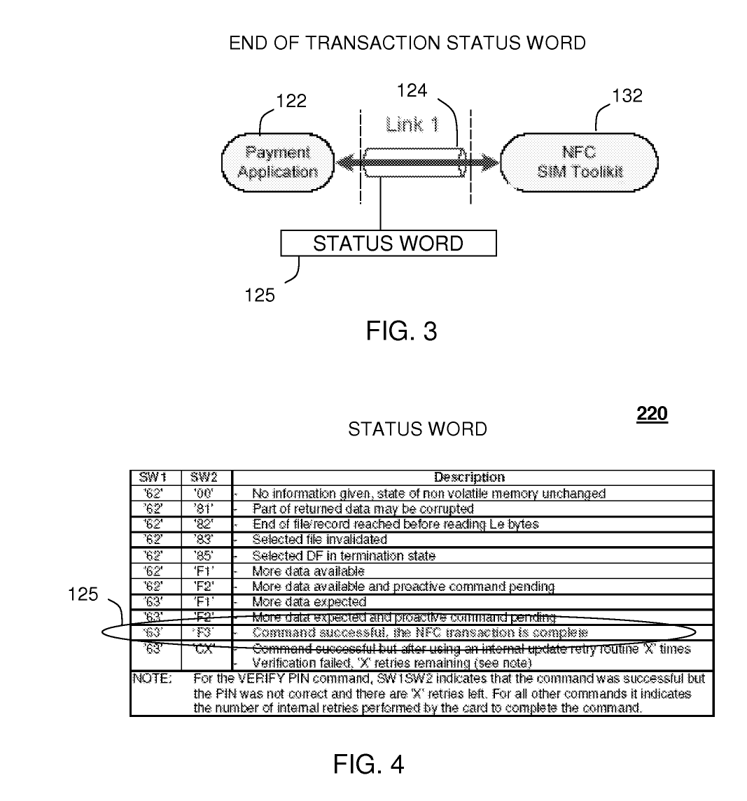

Notably, the NFC Payment Application 136 informs the application processor 120 of the end of transaction through an NFC-UICC toolkit status word that is a novel aspect of the invention. Referring to FIG. 3, an illustration for sending a new status word 125 over communication link 1 (124) from the NFC UICC Toolkit Application 132 to the Payment Application 122 is shown. The new status word can be transmitted in a packet data format. In particular, referring to FIG. 4, the ETSI TS 102 221 is modified to include the new status word 125. As an example, in compliance with ISO 7816, the new status word 125 can take the value 63XX and coded accordingly. The new status word 125 defines a way for detecting an end of an NFC payment transaction using an UICC that has NFC capabilities. The notification of the end of transaction is based on receiving the new status word 125 which signals the mobile device that the NFC payment has terminated on the NFC-UICC side. That is, the status word indicates that secure information stored in the UICC has been successfully read by a reader terminal. In practice, the new status word 125 can be sent in response to a Terminal Response command. The Terminal Response command is a standard command known in the art. The new status word 125 indicates that the Terminal Response command is successful and that an NFC transaction is complete, which may or may not be successful.

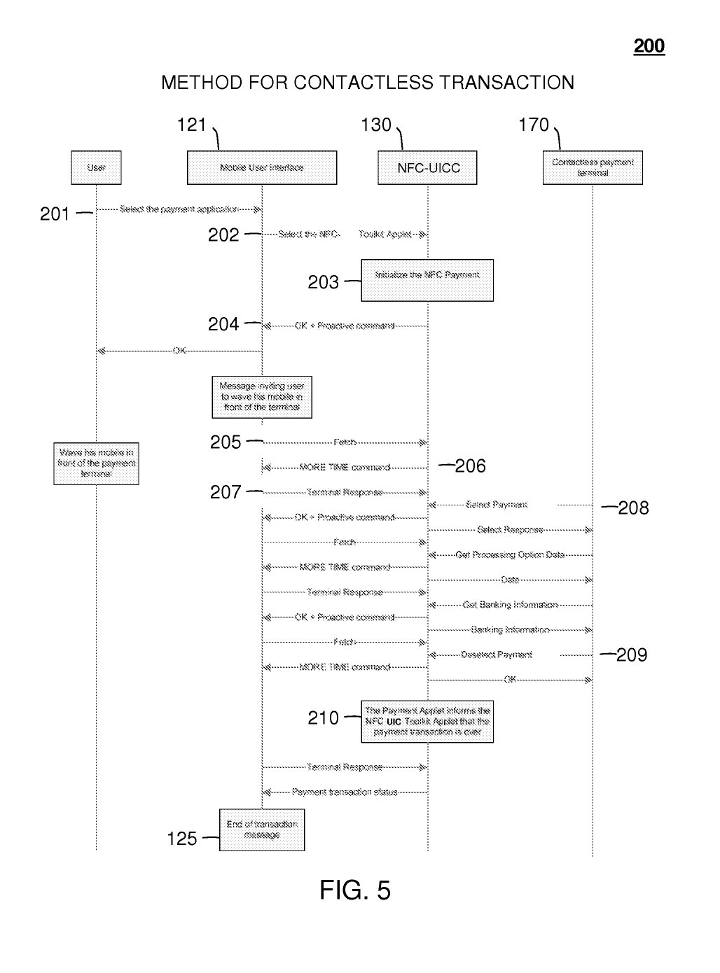

Referring to FIG. 5, a flowchart 200 illustrating an end of transaction notification during a payment transaction flow through proactive commands is shown. In particular, the flowchart 200 shows the new status word 125 sent from the NFC-UICC 130 to the user interface 121 of the mobile device. Data exchanges during the payment transaction between the mobile user interface 121, the NFC-UICC 130 and the contactless payment reader terminal 170 are shown on this diagram. It should be noted that the NFC UICC Toolkit Application 132 and the NFC Payment Application 136 are already loaded into the NFC-UICC at the time of the payment transaction. At step 201, the user selects the payment application 122 (See FIG. 2) from the user interface 121 of the user's NFC mobile device. At step 202, the application processor 120 (See FIG. 2) invokes a Select Contactless Payment function of an NFC-UICC API that selects the NFC-UICC Toolkit Application 132 from the NFC-UICC 130. The NFC-UICC Toolkit Application 132 informs the NFC Payment Application 136 to start a contactless payment session. After an initialization phase, at step 202, the payment application 122 enters a CONTACTLESS_PAYMENT_INITIATED state and informs the NFC-UICC Toolkit Application 136 of a successful initialization. At step 204, the NFC-UICC Toolkit Application 132 answers to its successful selection by requesting the application processor 120 (See FIG. 2) to retrieve a proactive command. Consequent to the successful payment application selection, the application processor 120 displays a message text in the user interface 121 (See FIG. 2) inviting the user to wave his mobile in front of the contactless payment terminal. Meanwhile, the mobile device initializes communication link 3 (138 See FIG. 2) between the NFC modem 140 and the NFC-UICC 130 to conduct the contactless payment (not shown on the flowchart 200).

The standard proactive command mechanism as defined in ETSI TS 102 223) is then executed. This involves executing a FETCH and a TERMINAL RESPONSE command on the mobile device in accordance with ETSI TS 102 223. The TERMINAL RESPONSE command is used to convey the NFC payment transaction status. It may be replaced by the execution of another new proactive command inviting the mobile device to retrieve information into the NFC-UICC 130 such as payment transaction status, payment transaction information, and the like. At step 205, the application processor 120 invokes the FetchProactiveCommand function of the NFC-UICC API to retrieve the proactive command the NFC-UICC 130 wants the mobile device to execute. At step 206, the NFC-UICC Toolkit Application 132 answers a sending of the MORE TIME command. In response to the MORE TIME command, the NFC-UICC 130 requests more time to finish execution of the contactless payment transaction without preventing the mobile device from sending any telecommunication 2G or 3G requests to the NFC-UICC 130. Thus, the application processor 120 invokes the TerminalResponseCommand function of the NFC-UICC API to answer the MORE TIME proactive command the NFC-UICC initiated at step 207. In response to this TERMINAL RESPONSE command, the NFC-UICC Toolkit Application 132 answers by requesting the application processor 120 to retrieve a proactive command, which is the MORE TIME command. This proactive command sequence between the NFC-UICC 130 and the mobile device is executed repeatedly, until the NFC-UICC Toolkit Application 132 notifies the mobile device of the end of the contactless payment transaction using the status word 125, or either that an error occurred. In one arrangement, the application processor 120 may intentionally introduce delay to account for NFC processes that may block during contactless payment transaction.

Briefly, the contactless payment transaction average time is 200 ms to 300 ms. This time corresponds to the time the reader terminal 170 needs to execute the credit card read sequence. It does not take into account the elapsed time between the payment application 122 selection by the user on the user interface 121 and the start of the payment transaction when the phone enters the RF field of the reader terminal 170. As this time may vary from a user to another without limitations, the MORE TIME proactive command is used by the NFC-UICC Toolkit Application to initiate communication with the terminal when the contactless payment is pending. As defined in ETSI TS 102 223: “The MORE TIME command shall be used, whenever possible, to allow the terminal access to the 3G or 2G functionality of the UICC [SIM or USIM] if a CAT (Card Application Toolkit) application is taking an unreasonable amount of time to complete execution”. First, this non-blocking command allows the NFC-UICC to request more time to finish the pending contactless payment initialized before providing the end of transaction status to the terminal. The MORE TIME proactive command also permits the NFC mobile device 120 to send 2G or 3G requests to the NFC-UICC without delaying them even if a contactless payment is pending.

When the mobile device enters an RF field of the payment reader terminal 170 (See FIG. 2), at step 208, the NFC-UICC 130 starts payment transaction. At step 209, a contactless session is established between the payment reader terminal 170 and the NFC-UICC 130. First, the payment reader terminal 170 selects the NFC Payment Application 136 that changes state to CONTACTLESS_PAYMENT_PENDING. If the selection of the NFC-UICC Payment Application 136 succeeds, the payment reader terminal 170 retrieves credit card information stored in the NFC-UICC 130. The NFC-UICC 130 may contain processing option data and banking information associated with the credit card. The NFC Payment Application 136 is informed of the end of transaction by detecting the last command request sent by the payment terminal that corresponds to the last command of the payment transaction flow. Once this command is detected, the NFC-UICC Payment Application 136 changes its internal state to CONTACTLESS_PAYMENT_END_OF_TRANSACTION. When entering the state CONTACTLESS_PAYMENT_END_OF_TRANSACTION, at step 210, the NFC Payment Application 136 informs the NFC UICC Toolkit Application of the end of the transaction. While the payment transaction is executed between steps 208 and 209, the NFC UICC Toolkit Application 132 has informed the mobile device that a payment transaction was pending using the MORE TIME proactive command.

Once the NFC UICC Toolkit Application 132 is notified of the end of the payment transaction 125 the NFC UICC Toolkit Application 132 stops sending the MORE TIME proactive command to the mobile device. The NFC UICC Toolkit Application 132 then sends the end of transaction as a specific status word 125 (proposed as a modification to the ETSI TS 102 221 as shown in FIG. 4) of the next TERMINAL RESPONSE command the mobile executes. This informs the mobile device that the contactless payment transaction is complete. Then, the NFC-UICC Toolkit Application 132 informs the NFC Payment Application 136 that the end of transaction status 125 has been sent to the mobile device. The NFC Payment Application 136 then changes state back to CONTACTLESS_PAYMENT_IDLE state, ready for processing any other contactless payment.

This mechanism also allows stopping the payment transaction flow if an error happens during the payment. For example, if an error occurred at the NFC Payment Application 136, the correspond ace of proactive commands informs the NFC-UICC Toolkit Application 132 and stops the MORE TIME proactive command execution loop. The NFC-UICC Toolkit Application 132 then follows the error status word to the mobile device using the TERMINAL RESPONSE command status. The NFC-UICC Toolkit Application 132 performs this in a similar way as for the end of transaction notification 125. It should also be noted that the NFC-UICC Payment application 136 may introduce additional intermediate states that can be used to provide more information to the application processor 120. This additional information can be displayed to the user. In particular, the new status word 125 can be reserved for NFC to carry more information to the user. For example, the user interface 121 could display a notification such as “you used a card that is not compatible with this reader, please try a different credit card”; or “please allow more time for the transaction to complete”.

The notification for the end of a contactless payment transaction in the NFC-UICC can be performed using only software changes. In such arrangement, the software changes are directed to the proactive command sequence between the mobile device and an NFC UICC Toolkit Application 132 in the NFC-UICC 130 (See FIG. 2). This involves a small change to the UICC Toolkit related specifications defined in ETSI 102-221, and ETSI 102 223. The software changes are also directed to the communication link 2 (134 See FIG. 2) between the NFC Payment Application 136 and the NFC UICC Toolkit Application 132 in the NFC-UICC 130 using existing mechanisms. Introducing the new status word 125 for identifying end of transactions can be extended to other payment-related events, as well as other contactless use cases using the NFC-UICC such as ticketing.

The end of transaction notification using the new status word 125 is reliable since it is based to the NFC Payment Application 136 state transitions, in contrast to current prior art unreliable end of transaction notification based on monitoring an RF field. The end of transaction notification using the new status word 125 allows the NFC mobile device 120 to access 3G or 2G functionality of the NFC-UICC 130 even if a contactless session is on-going. The end of transaction notification using the new status word 125 allows the mobile device to be informed of any event at and execution level of the NFC Payment Application 136. This includes processes performed beyond the end of the transaction such as error or data updates. The end of transaction notification using the new status word 125 provides reuse of the existing physical link 1 (124) and saves the need for extra hardware or GPIO (General Processor Input and Output) ports. The end of transaction notification using the new status word 125 provides a wide range of new functions using the proactive commands. For example, the NFC Payment Application 136 may now ask the user to enter his PIN code during the payment transaction sequence without disturbing the payment transaction. The NFC Payment Application 136 can store the amount of money paid during the contactless transaction in the UICC. Furthermore, with additional changes to the reader payment terminal, fidelity information such as fidelity points or coupon codes can be transferred back to the user. The NFC Payment Application 136 can dynamically let the user select payment cards with which the NFC-UICC 130 is compatible.

Where applicable, the present embodiments of the invention can be realized in hardware, software or a combination of hardware and software. Any kind of computer system or other apparatus adapted for carrying out the methods described herein are suitable. A typical combination of hardware and software can be a mobile communications device with a computer program that, when being loaded and executed, can control the mobile communications device such that it carries out the methods described herein. Portions of the present method and system may also be embedded in a computer program product, which comprises all the features enabling the implementation of the methods described herein and which when loaded in a computer system, is able to carry out these methods.

While the preferred embodiments of the invention have been illustrated and described, it will be clear that the embodiments of the invention are not so limited. Numerous modifications, changes, variations, substitutions and equivalents will occur to those skilled in the art without departing from the spirit and scope of the present embodiments of the invention as defined by the appended claims.

What is claimed is:

1. A system for contactless transaction validation suitable for use in a mobile device, comprising:
a Near Field Communication (NFC) modem for receiving radio frequency (RF) signals associated with a contactless data transaction;
an Universal Integrated Circuit Card (UICC) containing NFC applications, called NFC-UICC, communicatively coupled to the NCF modem for providing security to the contactless data transaction; and
an application processor communicatively coupled to the NFC-UICC for informing the mobile device of an end of transaction in the contactless data transaction,
wherein the NFC-UICC detects an end of transaction from the NFC modem via state transitions and informs the application processor via a status word that an end of transaction for the contactless data transaction has been confirmed.

2. The system of claim 1, wherein the contactless data transaction is a payment transaction and the end of transaction indicates that credit card information on the mobile device has been successfully read by an entity performing the contactless payment transaction with the NFC modem.

3. The system of claim 1, wherein the end of transaction corresponds to a contactless event related to software running on the NFC-UICC such as ticketing, cash card, access control, or WI-FI and Bluetooth set-up.

4. The system of claim 1, wherein the application processor includes a payment application presenting a graphical user interface that informs a user of the end of transaction for the contactless data transaction upon the application processor receiving the status word from the NFC-UICC for the end of transaction.

5. The system of claim 4, wherein the NFC-UICC further comprises:
an NFC application for monitoring data communication and determining the end of transaction for the contactless data transaction with the NFC modem; and
an NFC UICC toolkit application for providing proactive command support to the mobile device and providing notification of the end of transaction to the NFC payment application through the status word.

6. The system of claim 4, wherein NFC payment application implements a Java™ messaging Application Programming Interface (API) for conveying the status word and event occurrences between the NFC payment application and the application processor.

7. The system of claim 4, wherein the NFC-UICC further includes a shared memory for allowing the NFC application and the NFC UICC toolkit application to securely share information.

8. The system of claim 1, wherein the status word identifies the end of transaction and further includes account information such as credit balance, credit brand information, merchant information, or credit card logos, that is displayable on the mobile device.

9. The system of claim 1, wherein a Terminal Response proactive command includes the status word to convey NFC payment transaction.

10. A method for secure contactless payment transaction suitable for use in a mobile device comprising:
monitoring payment application state transitions during a payment transaction in real-time;
detecting a read event on a Near Field Communication Universal Integrated Circuit Card (NFC-UICC) of a mobile device during the payment transaction; and
notifying the mobile device of the read event via a status word for an end of transaction associated with a completion of the read event.

11. The method of claim 10, wherein monitoring payment application state transitions further comprises:
to initiate a contactless payment transaction, selecting an UICC toolkit application in a NFC-UICC;
in the UICC toolkit, informing an NFC payment application in the NFC-UICC that a payment transaction will occur;
during the contactless payment transaction, informing the UICC toolkit application of state transitions by the NFC payment application; and
informing the NFC mobile device of the end of transaction for the contactless payment through proactive commands sent by the UICC toolkit application.

12. The method of claim 10, wherein detecting a read event on an NFC-UICC card further comprises:
monitoring a time to execute a credit card read sequence of a pending contactless payment; and
providing a more time proactive command to request more time to complete the pending contactless payment if the time is insufficient to complete execution of the credit card read sequence.

13. A system for enhanced read complete indication, comprising:
a mobile device having a phone card for providing contactless data transactions and presenting transaction events through a user interface; and
a reader external from the mobile device that reads the phone card information from the mobile device when the mobile device is in proximity to a radio frequency (RF) field of the reader,
wherein, upon completion of a contactless data transaction, the reader sends an acknowledgment to the mobile device confirming that information from the phone card has been successfully read, and the user interface informs the user of the transaction status.

14. The system of claim 13, wherein the acknowledgment is a Terminal Response confirming receipt of transaction data, and the Terminal Response provides additional information related to the contactless data transaction.

15. The system of claim 14, wherein the additional information is a logo of a card issuer, a credit card brand, an application identifier, ticketing, cash card, access control, or configuration information (WI-FI or Bluetooth) that is displayable on the user interface.

16. The system of claim 13, wherein the mobile device further comprises:
a secure controller conducting contactless payment applications with the reader and a NFC/RFID controller; and
a messaging Applications Programming Interface (API) operatively coupled to the secure controller for informing the mobile device of contactless transaction events.

17. The system of claim 13, wherein the messaging API operates on hardware interrupts for signaling occurrence of contactless transaction events.

18. The system of claim 13, wherein the completion of data transactions is indicated based on event and application state transitions.

19. The system of claim 13, wherein the secure controller further comprises:
a communication interface to the mobile device;
a data manager having a secure protected memory for sharing secure information, a mailbox for sharing transaction events, an Events Status Register (ESR) that specifies the numbers of specific occurred event and the status, and a plurality of Data registers corresponding to the event and additional information.

20. The system of claim 13, wherein the acknowledgement is appended to a sequence of command responses between the mobile device and the reader in accordance with the near field communication method as defined in ISO-18092 and ISO-14443.
